(19) United States
(12) Patent Application Publication
(10) Pub. No.: US 2011/0136073 A1
(43) Pub. Date: Jun. 9, 2011

(54) DENTAL MEASURING DEVICE

(76) Inventor: Thomas Basta, Los Gatos, CA (US)

(21) Appl. No.: 12/960,368

(22) Filed: Dec. 3, 2010

Related U.S. Application Data
(60) Provisional application No. 61/266,436, filed on Dec. 3, 2009.

(51) Int. Cl. A61C 19/04

(52) U.S. Cl. 433/73

(57) ABSTRACT

Dental devices are disclosed which allows a dental laboratory to accurately create upper front teeth and dentures to the dentist's specific instructions. The interpupillary line and the incisal lines are used to fabricate teeth which are more symmetrical and therefore are more esthetically pleasing than prior devices and procedures. The angle and the distance between the interpupillary line and the incisal line are measured and recorded with a smile guide device.

### CROSS-REFERENCE TO RELATED APPLICATIONS

This application claims the benefit of U.S. Provisional Patent Application 61/266,436 filed on Dec. 3, 2009.

### STATEMENT REGARDING FEDERALLY SPONSORED RESEARCH AND DEVELOPMENT

Not applicable

### FIELD OF THE INVENTION

The present invention relates generally to dental devices used to assist the dental practitioner in measuring critical features in the design of prosthetic teeth.

### BACKGROUND OF THE INVENTION

The devices and procedures of the present invention are advantageous to dental professionals, particularly gnathologists, restorative dentists or a dentist working with dental technicians to create models and prosthetic teeth. Gnathology is the study of the masticatory system, including its physiology, functional disturbances, and treatment. Because it is not part of regular dental school training at present, most learn by participating in “study clubs” with experienced mentors. Gnathology requires extremely accurate dentistry.

At present, there are several devices and methods used to measure features of a person's face to create symmetric and functional prosthetic teeth e.g. crowns, veneers and dentures. The lack of a straightforward and accurate system for adapting individual features of a patient's face, mouth and teeth is a source of frustration for dentists, dental technicians and patients. The present invention is a system to assist the dental technician in fabricating the appropriate dental prostheses and is intended to eliminate the necessity of having to reproduce the dental prostheses after they have been fabricated because they do not fit well or are not aesthetically pleasing. The challenge for the dental professionals and technicians is that faces, teeth, and skulls are not completely symmetrical and vary substantially from patient to patient.

A facebow is a device which is used to translate the relationship between the upper jaw and axis of rotation of the lower jaw to a dental articulator. The facebow typically has a sliding adjustable stylus which is positioned on each temporormandibular (TMJ) joint. The facebow measurements are generally used to establish a relationship between the maxillary arch and the center of rotation of the (facial) condyles. A condylar joint is a modified biaxial ball and socket joint in which the joint surfaces are elongated or ellipsoidal. The center of rotation of the condylar joint is determined by rotation of the medial pole of the condyle rotating against the triangular glenoid fossa in the skull.

The facebow measurements are then transferred to a dental articulator to enable the articulator to simulate the movement of the jaw with the prosthetic teeth. The facebow includes a bite fork which is held by the anterior maxillary (upper front) teeth of the patient. The bite fork enables the dental professional in the measurement of the incisal plane angle. In fabricating the prosthetic teeth, the bite fork is usually mounted on the lower frame of the dental articulator in a position to receive the upper dental cast of the patient's teeth.

An earbow is an instrument which allows the dental professional to relate an upper arch or an upper cast to an anatomic average position of the condylar or axis of the TMJ using the ear hole, rather than the center of the axis of rotation of the TMJ.

The prior art procedures are somewhat complicated and time consuming, in some instances requiring a number of components which should be sterilized before each use. As a result, many dental practitioners do not use the dental articulator but instead, may try much less accurate techniques. Even when the dental articulator is used, prior art devices often use arbitrary measurements.

For example, in Lindekugel U.S. Pat. No. 6,152,732, the bite fork is oriented by measuring 43 millimeters above the lateral incisor edge on the right; central or lateral incisors which are used as a third reference point. The first reference point in prior art procedures is positioned just underneath the right eye of the patient. The location of the reference point is typically noted by a mark, such as an ink mark on the patient's face. The facebow in the other prior art procedures has a reference pointer which swings inwardly towards the patient's face to the reference point underneath the patient's eye. The patient can be disturbed by this motion which often results in inaccurate facebow placement since the patient frequently moves in response to the use of the pointer.

Further, many prior art procedures use a true hinge axis facebow such that the articulator is oriented to the hinge axis plane rather than the interpupillary line. The patient's jaw or hinge axis is rarely, if ever, parallel to the interpupillary line. It is difficult to use the hinge plane axis as the reference line to create the most pleasing, symmetrical and esthetic smile line. The objective of the present invention is to provide unique tools to make the necessary measurements with simplified procedures to create functional and aesthetically pleasing prosthetic teeth. A further objective of the present invention is to create an ideal smile line following the esthetic curve of the lower lip during a full smile. An aesthetic ideal can be achieved by creating anterior teeth with an incisal edge and a smile line which is related to the interpupillary line or the inner canthus line.

### SUMMARY OF THE INVENTION

In order to systematize the process and make accurate measurements in accordance with the present invention, it is necessary to determine the line made by connecting the pupil of each eye which forms the interpupillary line. The interpupillary line is used as the reference plane from which the angle of the incisal plane is measured. A second line, the incisal line, is the line which intersects the bottom of both incisors. The incisal line is approximately parallel to the interpupillary line, but it is seldom completely parallel in people. The inner canthus line may also be used as a reference. The canthus is where the upper and lower eyelids meet near the bridge of the nose. The inner canthus line is formed by drawing a line through the inner canthus of each eye.

The dental professional takes an ear bow or facebow measurement of the patient's face. The earbow has an arm which is generally parallel to the interpupillary line and a bite fork which is attached to the arm. When the facebow or earbow is mounted to any semi-adjustable or adjustable articulator, it will orient the upper and lower member of the articulator holding the molded jaw and teeth such that they are parallel to the interpupillary line.

The smile guide shown in FIG. 1 provides a way to measure the angle and the distance between the incisal line and the interpupillary line. The photograph of the patient may be taken and used at 100% scale so that it is equal to the actual size of the patient. [It is extremely difficult, if not impossible, however, to measure the length and width of the teeth with sufficient accuracy from a photograph.] The smile guide is used to measure the precise width and length of the incisors as well as measuring the angle and the distance between the incisal and the interpupillary line.

The most pleasing smiles (and faces) are symmetrical: the incisal lines of the upper front teeth should be parallel to the interpupillary line and the midline of the central incisors is perpendicular to the interpupillary line. [The midline is the line between the two central incisors] The smile guide is very effective in determining the measurements of the incisal lines in relation to the interpupillary line and how the midline is aligned in relation to the interpupillary line. In cases where the patient's smile does not fall within the pleasing smile standards and is unattractive, the smile guide can relate the degree of tilting of the incisal line and the midline with respect to the interpupillary line.

Using the facebow of the present invention, the adjustable side arms are placed on the hinge axis points on each side of the face and to a selected third reference point of the patient. A first reference rod is attached to the bite fork and is horizontally oriented across the face. A second reference rod is perpendicular to the first reference rod (vertically oriented to the face). The upper portion of the second reference rod is placed at the selected third reference point. A third reference rod or the interpupillary line indicator is removeably connected perpendicularly to the second reference rod. The interpupillary line indicator is adjusted with a stylus so that it coincides with the patient's interpupillary line and the device is locked into that position. The facebow is mounted to either the fully adjustable articulator of the present invention or the conventional semi-adjustable articulator. The semi-adjustable, conventional articulator is used with the less accurate earbow.

The fully adjustable articulator of the present invention when used with the facebow permits the dental professional to locate the actual hinge axis of the patient, the hinge angle and the range of motion of the patient's jaw. The jaw is a joint which both articulates and glides. Therefore, using fully-adjustable articulator, the facebow and the smile guide, the patient's jaw and teeth can be accurately reproduced. The articulator rests on a bench top which may not be completely level. A line level device is placed on the lab bench and if the bench is not perfectly level, a (preferably) erasable line is placed next to the margin of the level bubble. The level is then placed on the stylus of the pupillary line indicator and the leveling screws of the articulator are adjusted until the level conforms to the reading provided when the level was placed on the lab bench.

Other features and advantages of the present invention will become apparent from the following more detailed description, taken in conjunction with the accompanying drawings, which illustrate, by way of example, the principles of the invention.

### DESCRIPTION OF THE DRAWINGS

FIG. 1 is a perspective view of the Smile Guide;

FIG. 2 is an illustrative view of the invention, showing the Smile Guide in the process of being aligned on the face of a patient;

FIG. 3 is an illustrative view of the invention showing the Smile Guide as used in measuring the facial anatomy of a patient;

FIG. 4 is a front view of the fully adjustable articulator of the present invention;

FIG. 5 is a side view of the fully adjustable articulator of the present invention;

FIG. 6 is a back view of the fully adjustable articulator of the present invention;

FIG. 7 is a view of the facebow of the present invention; and

FIG. 8 is a view of the facebow of the present invention as mounted on an articulator standing on a bench with the level indicator.

### DETAILED DESCRIPTION OF THE INVENTION

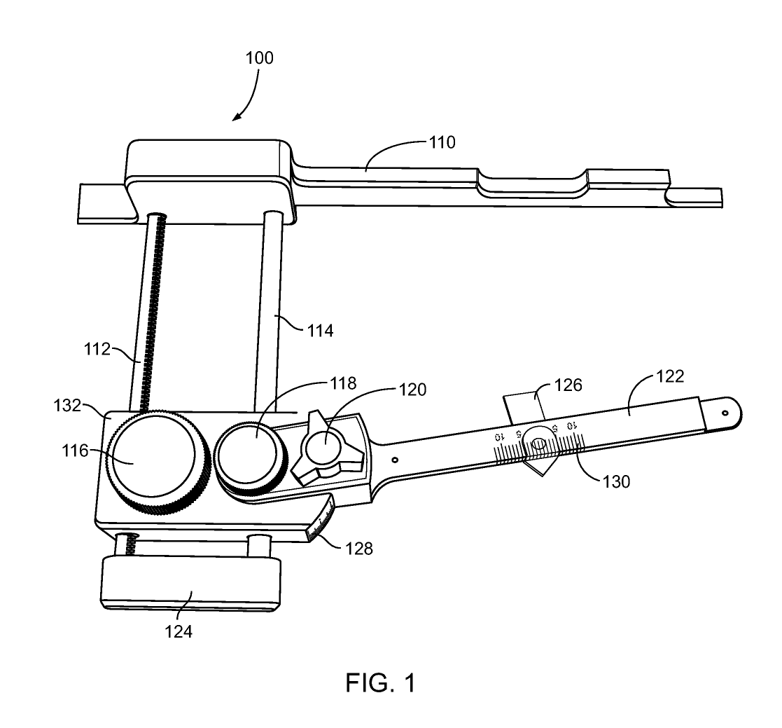

The dentist typically supplies the technician with a full face photograph at 100% scale of the patient smiling while showing as much of the anterior teeth as possible. An exaggerated or “forced smile” can be effectively used as part of the procedure to create the photograph for the dental technician. The smile guide 100 shown in FIG. 1 is then used to make measurements from either the photograph or the actual patient.

Referring to FIG. 1, the smile guide includes a longitudinally extending base 110 which is adapted to sit on a flat surface. Linear gears 112 and 114 are parallel to each and are inserted into block 124 and base 110. A traveler 132 moves longitudinally up and down on the linear gears. A rotary gear (not shown) engages the linear gears thereby permitting longitudinal movement on the linear gears. An articulating arm 122 is connected to the traveler 132 at a pivot point. The arm 122 may be articulated by rotating knob 118. The articulating arm 122 is secured into position with a locking mechanism when the dental practitioner tightens control 120. The traveler is secured into its selected position with a locking mechanism consisting of locking gears which are engaged with the linear gear when the practitioner rotates knob 116. A scale 128 is provided with markings between “0” and +10 and −10 to provide measurement of the angle of articulation of the arm 122. A second scale 130 is provided on the arm 122 for e.g. measuring the length and width of the teeth. A moveable pointer 126 is provided for ease in reading the width measurements.

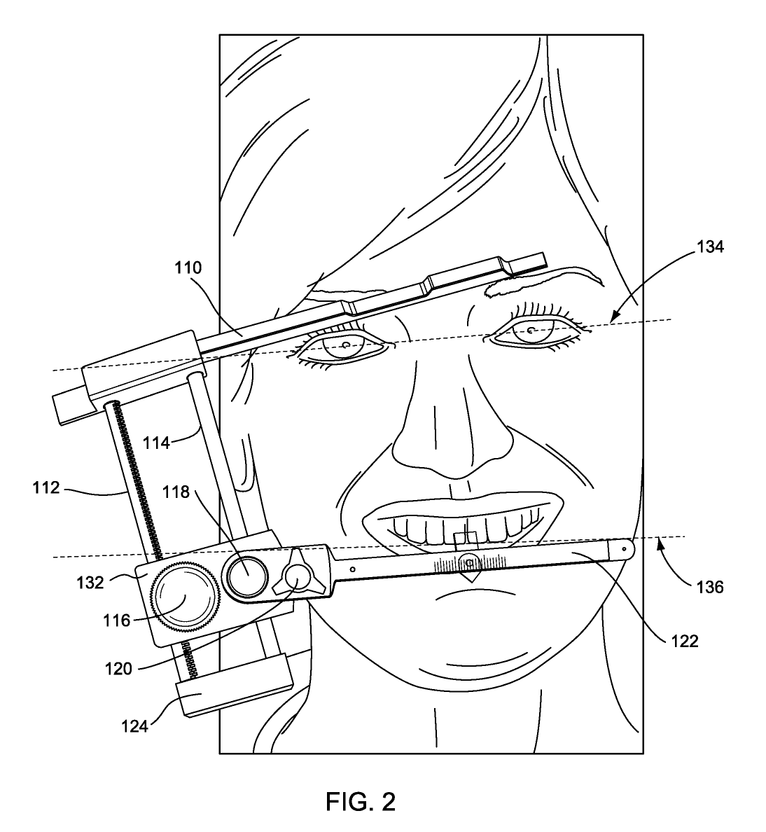

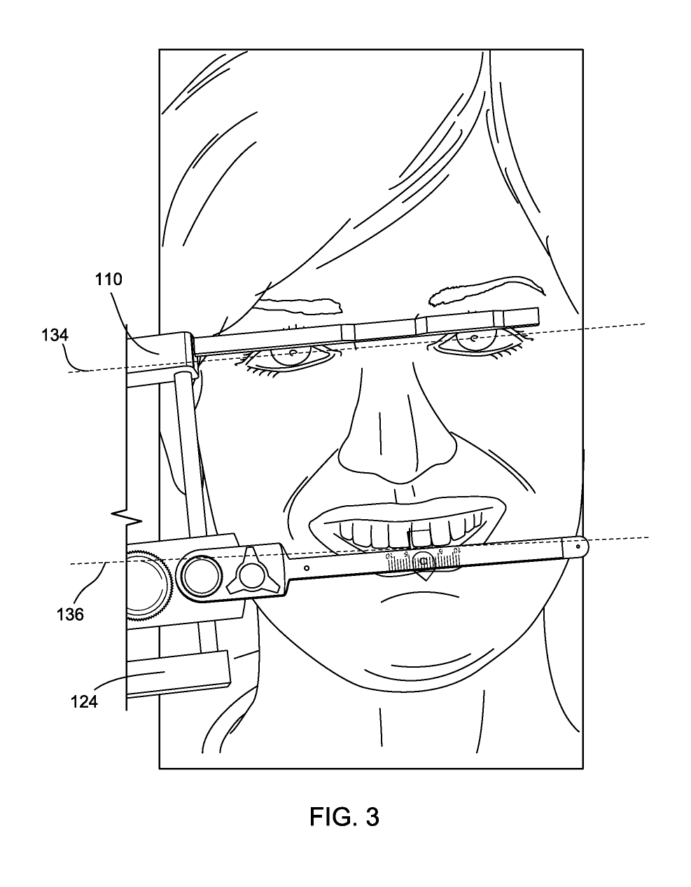

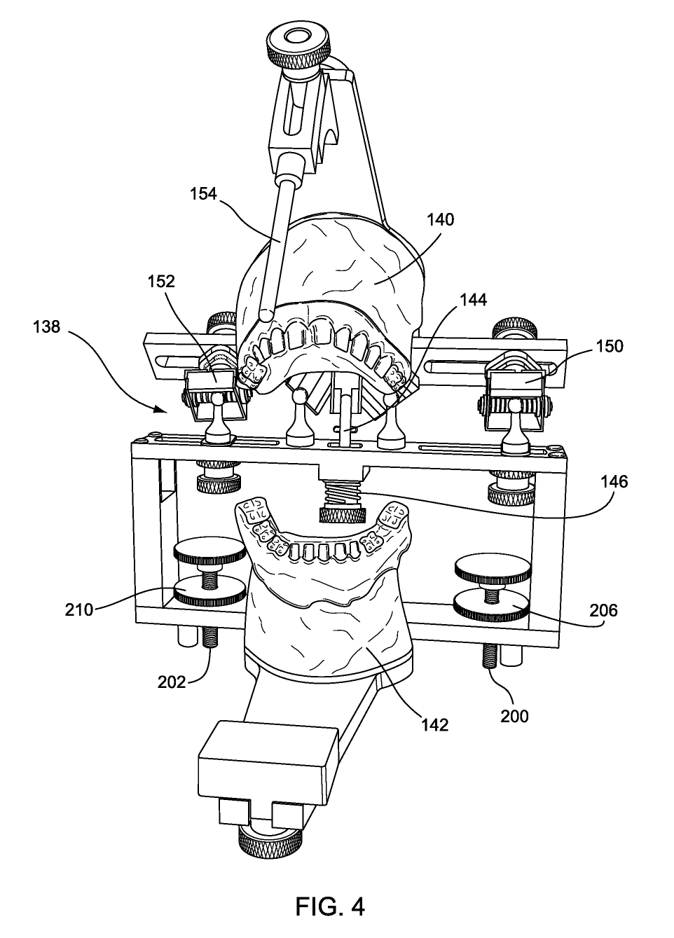

The interpupillary line 134 and the incisal line 136 connecting two points under the front incisors are drawn on the patient's photograph. The longitudinal base 110 of the smile guide 100 is aligned with the interpupillary line 134 as shown in FIGS. 2 and 3. The articulating arm 122 is aligned with the incisal line 136 while moving the traveler 132 up and down the linear gears 112. The traveler 132 is longitudinally secured in place by turning knob 116 which engages the locking mechanism. The articulating arm is secured in its proper alignment with the incisal line 136 and secured in the proper aligned location with control 120. A measurement from −10 to +10 is taken and recorded from scale 128. With the smile guide locked in the proper position for the individual patient, the precise angle and distance between the interpupillary line and the incisal line are measured and recorded. The smile guide 100 is then rotated 360 degrees and longitudinal base 110 is slid under the lower portion of the articulator 138 [FIGS. 4-6]. The smile guide 100 stands upright on the laboratory bench on longitudinal base 110 with the articulator 138. The mold of the upper portion of the patient's teeth 140 is mounted on the articulator 138 and is aligned using the angle and distance measurements which have been measured by the smile guide.

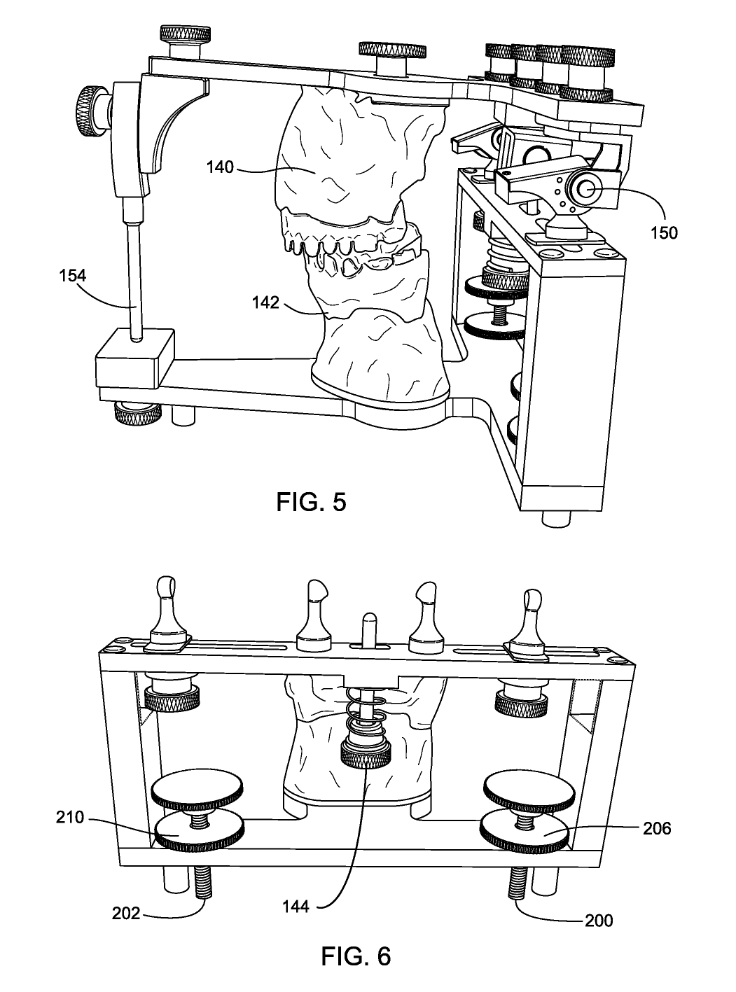

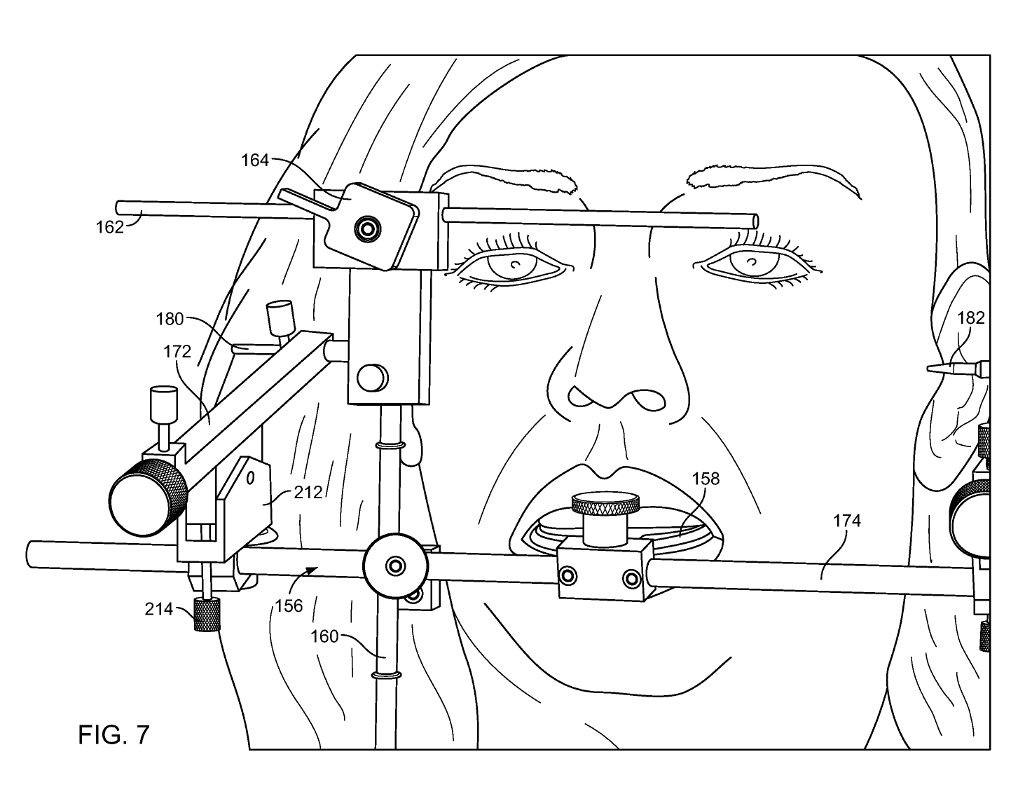

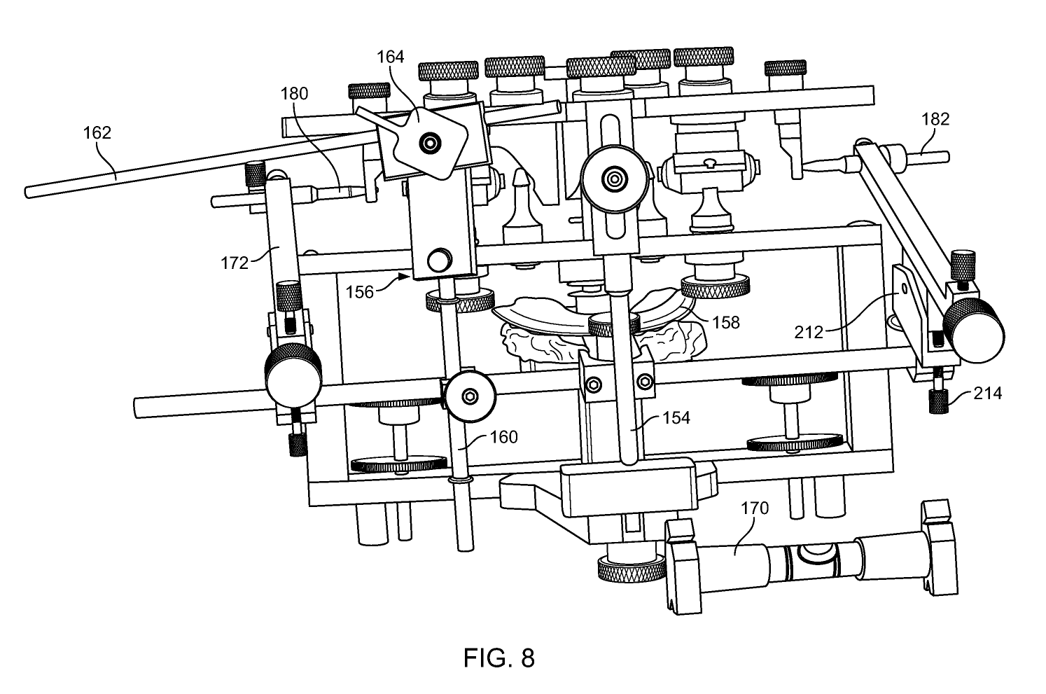

The fully-adjustable articulator of the present invention has hinges 150 and 152, as shown in FIG. 4 and FIG. 5 connecting the upper half of the articulator with the lower half of the articulator. The lower half of the dental mold of the patient's teeth 142 is mounted on the lower half of the articulator. The two halves of the articulator are removably interconnected with a latch 144 and a spring-loaded release mechanism 146. The lower half of the articulator is shown in FIG. 6. The articulator is adjustable so that the dental professional can set the precise distance between the upper and lower molded teeth. An adjustable separating rod 154 is provided with the articulator to prevent the upper and lower molds of the teeth from striking each other and breaking or scratching.

The true axis facebow 156 of the present invention is shown in FIG. 7. A bite fork 158 is inserted into the patient's mouth as shown in FIG. 7. The bite fork 158 measures the angle of the incisors. Using the true axis facebow 156, the side arms 172 are adjusted such that adjustable rods 180 and 182 are placed on the hinge axis points at each center of rotation of the condyles which are the first and second reference points. The side arms 172 are adjustable using the clamp 212 and the adjustment screw 214. A third reference rod 160 is provided at a selected third reference point. An interpupillary line indicator rod 162 is mounted perpendicularly to the third reference rod 160 and is generally parallel to central rod 174. The interpupillary line indicator is placed on the interpupillary line and secured into its longitudinal and horizontal position on the third reference rod 160 with the stylus 164.

As shown in FIG. 7, the true axis face bow is then mounted to an adjustable or semi-adjustable articulator. As the articulator and the work bench may not be completely parallel to each, the dental practitioner can compensate for it by taking a measurement of the level of work bench. The interpupillary line indicator (ILP) rod 162 is placed on the third reference rod of the face bow. A line level indicator 170 is placed on the lab bench holding the articulator. The level indicator 170 is marked with a preferably erasable line on the margin of the bubble inside the line level. The level indicator 170 is placed on the stylus of the pupillary line indicator rod. The leveling screws 200 and 202 of the articulator are inserted into washers 206, 210, and are adjusted until the level reading is exactly the same as the level reading when the level was located on the lab bench. The height of the leveling screws are recorded in the patient's records with the patient's other measurements.

Particular terminology used when describing certain features or aspects of the invention should not be taken to imply that the terminology is being redefined herein to be restricted to any specific characteristics, features, or aspects of the invention with which that terminology is associated. In general, the terms used in the following claims should not be construed to limit the invention to the specific embodiments disclosed in the specification, unless the above Detailed Description section explicitly defines such terms. Accordingly, the actual scope of the invention encompasses not only the disclosed embodiments, but also all equivalent ways of practicing or implementing the invention.

The above detailed description of the embodiments of the invention is not intended to be exhaustive or to limit the invention to the precise form disclosed above or to the particular field of usage mentioned in this disclosure. While specific embodiments of, and examples for, the invention are described above for illustrative purposes, various equivalent modifications are possible within the scope of the invention, as those skilled in the relevant art will recognize. Also, the teachings of the invention provided herein can be applied to other systems, not necessarily the system described above. The elements and acts of the various embodiments described above can be combined to provide further embodiments.

Changes can be made to the invention in light of the above “Detailed Description.” While the above description details certain embodiments of the invention and describes the best mode contemplated, no matter how detailed the above appears in text, the invention can be practiced in many ways. Therefore, implementation details may vary considerably while still being encompassed by the invention disclosed herein. As noted above, particular terminology used when describing certain features or aspects of the invention should not be taken to imply that the terminology is being redefined herein to be restricted to any specific characteristics, features, or aspects of the invention with which that terminology is associated.

I claim:

1. A dental measuring device for use by a dental practitioner comprising:
an elongated base adapted to stand upright on a flat surface;
a lower base parallel to said elongated base;
a traveler having a position adapted to be longitudinally adjustable between said elongated base and said lower base;
an articulating arm attached to said traveler at a pivot point such that said arm rotates around said pivot point, said arm forming a variable angle relative to the plane of said elongated base as the arm articulates around said pivot point;
a first scale marked on said traveler to indicate said angle;
a first locking device to secure said articulating arm into a position chosen by the practitioner using said first scale;
a second locking device for securing the longitudinal location of said traveler between said elongated base and said lower base.

2. The dental device of claim 1 further including a second scale on said articulating arm for measuring the width of the teeth.

3. The dental device of claim 1 wherein said elongated base, said traveler, and said lower base are interconnected by two linear gears.

4. The dental device of claim 3 wherein said linear gears are parallel to each other.

5. The dental device of claim of claim 3 wherein said linear gears are inserted through said traveler, said elongated based and said lower base.

6. The dental device of claim 3 wherein said second locking device is a locking gear in connection with a knob, said locking gear engaging said linear gear, upon turning the knob.

7. The dental device of claim 2 wherein said elongated base, said traveler, and said lower base are interconnected by two linear gears.

8. The dental device of claim of claim 2 wherein said linear gears are inserted through said traveler, said elongated based and said lower base.

9. The dental device of claim 1 wherein said second locking device is a locking gear in connection with a knob, said locking gear engaging said linear gear, upon turning the knob.

10. The dental device of claim 2 wherein said second locking device is a locking gear in connection with a knob, said locking gear engaging said linear gear, upon turning the knob.
